(19) United States
(12) Patent Application Publication
(10) Pub. No.: US 2024/0091817 A1
(43) Pub. Date: Mar. 21, 2024

(54) DEVICE FOR CLEANING SUPPORT BARS OF A FIRST WORKPIECE SUPPORT OF A FIRST LASER CUTTING MACHINE

(71) Applicant: Meyer BlechTechnik AG, Grosswangen (CH)

(72) Inventor: Urs MEYER, Grosswangen (CH)

(73) Assignee: Meyer BlechTechnik AG, Grosswangen (CH)

(21) Appl. No.: 18/243,708

(22) Filed: Sep. 8, 2023

(30) Foreign Application Priority Data
Sep. 19, 2022 (EP) 22196410.9

(51) Int. Cl. B08B 1/00; B23K 26/70

(52) U.S. Cl. CPC B08B 1/008; B08B 1/005; B23K 26/702

(57) ABSTRACT

The device for cleaning support bars of a first workpiece support of a first laser cutting machine, which support includes support bars running substantially parallel to one another and each extending longitudinally, includes a supporting structure supporting a cleaning head and a movement mechanism for moving the head relative to the supporting structure. The movement mechanism includes a lifting mechanism for moving the head vertically and a longitudinal carriage for moving the head along the support bars. The supporting structure has a carriage for moving the supporting structure on a floor surface transversely, which results in the supporting structure being movable transverse to the support bars. The supporting structure is movable by the carriage towards and away from the first laser cutting machine location and towards a a second laser cutting machine location to clean support bars of a second workpiece support of the second laser cutting machine.

### CROSS REFERENCE TO RELATED APPLICATIONS

Applicant claims priority under 35 U.S.C. § 119 of European Application No. 22196410.9 filed Sep. 19, 2022, the disclosure of which is incorporated by reference.

### TECHNICAL FIELD

The present invention relates to a device for cleaning support bars of a first workpiece support of a first laser cutting machine and to a method for cleaning support bars of a first workpiece support of a first laser cutting machine.

### PRIOR ART

Workpiece supports of laser cutting machines typically have a plurality of support bars arranged parallel to each other for supporting workpieces. When a workpiece is cut by means of a laser, deposits accumulate on the support bars. In the case of workpieces that include a metallic material that is melted when the workpiece is cut, particularly stubborn deposits form on the support bars. In order to be able to use the support bars multiple times, they must be cleaned.

From EP 2 338 616 B1, an automatic support bar cleaner for cleaning support bars of workpiece supports on machine tools for thermal cutting of workpieces with a cleaning member carrier is known, on which at least one cleaning member is provided and with which a lateral longitudinal surface of the support bar is associated when cleaning a support bar. The support bar cleaner has a transverse drive which, during cleaning of a support bar, periodically moves the cleaning member carrier and the support bar relative to one another towards each other and away from each other transverse to a longitudinal side surface of the support bar associated with the cleaning member carrier. In addition, the support bar cleaner has a parallel drive to move the cleaning member carrier and the support bar relative to each other with a periodic lifting movement to remove deposits on the support bar.

An automatic device for cleaning support bars of workpiece supports is known from EP 1 655 081 B1. The automatic device has a feed drive with a feed member which is placed on a support bar to be cleaned in order to generate the feed movement. In this manner, a significant portion of the feed force is not applied by an operator of the device, but by a dedicated drive thereof.

Known from EP 2 082 813 B1 is an automatic arrangement for cleaning support bars of a workpiece support having a transport device for moving the workpiece support along a transport axis and having a service device which has a tool for cleaning the support bars. The service device can be moved along two directions each running perpendicular to the transport direction, thereby allowing a lifting movement of the service device and a movement of the service device transverse to the support bars.

From DE 10 2017 210 182 A1, a laser cutting machine with a service device for cleaning support bars is known. The laser cutting machine has a movement mechanism for moving the service device along three directions extending perpendicular to each other.

### SUMMARY OF THE INVENTION

The underlying object of the present invention is to provide an improved device for cleaning support bars of workpiece supports of laser cutting machines. Another object is to provide an improved method for cleaning support bars of a first workpiece support of a first laser cutting machine. These objects are achieved by a device for cleaning support bars of a first workpiece support of a first laser cutting machine having the features of a first aspect of the invention and by a method for cleaning support bars of a first workpiece support of a first laser cutting machine having the features of a second aspect of the invention.

The device is designed for cleaning support bars of a first workpiece support of a first laser cutting machine which is located at a predeterminable first location, wherein the first workpiece support of the first laser cutting machine has a plurality of support bars, which are arranged to run substantially parallel to one another and each extend along a longitudinal direction, for supporting a workpiece. The device has a supporting structure supporting a cleaning head having a cleaning tool for cleaning the support bars of the first workpiece support, and a movement mechanism for moving the cleaning head relative to the supporting structure. The movement mechanism has a lifting mechanism for lifting and lowering the cleaning head in a vertical direction to place the cleaning head on the support bars of the first workpiece support so that a support bar comes into contact with the cleaning tool, and to lift the cleaning head from the support bars of the first workpiece support after cleaning the support bar. The movement mechanism has a longitudinal carriage for moving the cleaning head along the longitudinal direction to move the cleaning head along the support bars of the first workpiece support. The supporting structure has a carriage for moving the supporting structure on a floor surface at the first location along a transverse direction extending transverse to the longitudinal direction, as a result of which the supporting structure is designed to be movable transverse to the support bars to move the cleaning head from support bar to support bar so that multiple support bars of the first workpiece support are enabled to be successively cleaned by the cleaning head. The supporting structure is movable over the floor surface by means of the carriage in such a manner that the supporting structure is configured to be moved towards the first location of the first laser cutting machine in order to clean support bars of the first workpiece support of the first laser cutting machine, and that the supporting structure is configured to be moved away from the first location of the first laser cutting machine and towards a predeterminable second location of a second laser cutting machine in order to clean support bars of a second workpiece support of the second laser cutting machine by means of the cleaning head.

Advantageously, the device allows support bars of workpiece supports to be cleaned in a fully automated manner, without the device or the supporting structure or the cleaning head having to be moved manually by a user. For this reason, the device includes the movement mechanism with the lifting mechanism and the longitudinal carriage in order to be able to move the cleaning head vertically and along the support bars, and the carriage which makes it possible to move the supporting structure together with the movement mechanism transverse to the support bars. Due to the fully automated cleaning of the support bars, workpiece supports can advantageously be cleaned in an efficient and particularly quick manner.

In addition, the device offers the advantage of being designed to be spatially mobile and not being a component of a laser cutting machine itself. In this manner, workpiece supports of different laser cutting machines can be cleaned independently of the location of the laser cutting machines. This is made possible by the carriage so that the supporting structure is designed to be movable across the floor surface. The device is a self-sufficient system that is not dependent on an existing system periphery of a laser cutting machine. Advantageously, no technical modification to the existing laser cutting machine is required for commissioning the device.

In one embodiment, the cleaning head has a guide plate for supporting the cleaning head on the support bars. Advantageously, a vertical position of the cleaning head relative to the support bars is predetermined or defined by the guide plate during cleaning of the support bars. This determines how far the cleaning head is lowered by means of the lifting mechanism and how far a support bar is to engage in the cleaning tool.

In one embodiment, the device has a guide arm connected to the supporting structure and alignable along the support bars. The cleaning head is guided on the guide arm in such a manner that the cleaning head can be moved along the guide arm (in the longitudinal direction of the guide arm) by means of the longitudinal carriage. The longitudinal carriage can be arranged on the cleaning head to move the cleaning head along the guide arm. Alternatively, the supporting structure can also include the longitudinal carriage and the cleaning head can be fastened to the guide arm, wherein the longitudinal carriage is designed to move the guide arm together with the cleaning head in the longitudinal direction. Alternatively, the guide arm can be designed as a telescopically extendable structure which carries the cleaning head and which is extendable in the longitudinal direction by means of the longitudinal carriage to move the cleaning head along the longitudinal direction.

In one embodiment, the guide arm is pivotably mounted on the supporting structure within a predeterminable solid angle. Advantageously, a connection between the guide arm and the supporting structure is thus designed to be flexible and not rigid. This flexibility can protect the device from damage, for example damage to the guide arm, since large forces can be transmitted to the guide arm and the supporting structure during cleaning of solidified metallic deposits on the support bars, for example.

In one embodiment, the cleaning tool of the cleaning head has two cleaning members opposite each other with respect to the transverse direction for receiving one of the support bars. The cleaning members are each designed to be movable along the transverse direction and the vertical direction, as a result of which the cleaning members are designed to be movable relative to side surfaces of the one of the support bars, the side surfaces extending transverse to the transverse direction, in order to process deposits on the one of the support bars by grinding and/or scraping. Advantageously, deposits can be removed particularly efficiently from the support bars by means of a cleaning head designed in this manner.

In one embodiment, the supporting structure is configured to be coupled to a guide rail arranged on a base and extending along the transverse direction, in order to enable the supporting structure to be moved along the transverse direction. Advantageously, this ensures rectilinear movement along the transverse direction. The base can be formed by the floor surface, for example. Alternatively, the base can also be formed by a portion of the first or second laser cutting machine that is elevated relative to the floor surface. However, a guide rail is not required. The carriage can alternatively be programmed to move the supporting structure along a guide line. Alternatively or additionally, a laser beam can also be used to guide the supporting structure along the transverse direction. A guide rail is not absolutely necessary.

In a refinement of the above-mentioned embodiment, the carriage can comprise at least one guide roller which is arranged on an underside of the supporting structure facing the floor surface and which is configured to be coupled to the guide rail in such a manner that the supporting structure is enabled to be moved in the longitudinal direction of the guide rail guided on the guide rail by means of the guide roller. Advantageously, the supporting structure is configured to be moved along the transverse direction in a particularly simple manner. For coupling the guide roller to the guide rail, the guide roller can include, for example, a notch which is provided for receiving the guide rail. However, it is also possible that the supporting structure is not coupled to the guide rail by means of a guide roller. For example, the supporting structure can include a component having a ball bearing for engaging the guide rail.

In one embodiment, the supporting structure includes a lifting/lowering mechanism for lowering the guide roller onto the guide rail and for lifting the guide roller from the guide rail.

In one embodiment, the carriage of the device has at least three rollers arranged on an underside of the supporting structure facing the floor surface for moving the supporting structure on the floor surface. As a result, the supporting structure is designed to be spatially mobile. Advantageously, this allows the device to be used at multiple different locations of multiple laser cutting machines which can be placed separately from each other at spatially distributed locations.

In one embodiment, at least one of the rollers and/or the at least one guide roller can be driven by means of a drive in order to move the supporting structure along the guide rail.

A method for cleaning support bars of a first workpiece support of a first laser cutting machine by means of a device according to the invention comprises the following method steps: The supporting structure is moved to the location of the first laser cutting machine; the supporting structure is aligned in such a manner that the cleaning head is movable along the support bars; the cleaning head is placed on the support bars of the first workpiece support of the first laser cutting machine by means of the lifting mechanism so that one of the support bars comes into contact with the cleaning tool; the cleaning head is moved along the one of the support bars by means of the longitudinal carriage, thereby cleaning the one of the support bars.

In one embodiment, the method comprises the following further method steps: The cleaning head is lifted from the support bars by means of the lifting mechanism; the supporting structure is moved along the transverse direction by means of the carriage, wherein the cleaning head is moved towards another one of the support bars; the cleaning head is placed onto the support bars of the workpiece support of the first laser cutting machine by means of the lifting mechanism, wherein the cleaning tool comes into contact with the other one of the support bars; the cleaning head is moved along the other one of the support bars by means of the longitudinal carriage, thereby cleaning the other one of the support bars.

In one embodiment, the method comprises the following further method steps: the cleaning head is lifted from the first workpiece support of the first laser cutting machine by means of the lifting mechanism; the supporting structure is moved towards the second laser cutting machine and aligned in such a manner that the cleaning head is movable along support bars of the second workpiece support of the second laser cutting machine; the cleaning head is placed onto the support bars of the second workpiece support of the second laser cutting machine by means of the lifting mechanism, wherein the cleaning tool comes into contact with one of the support bars of the second workpiece support; the cleaning head is moved along the one of the support bars of the second workpiece support of the second laser cutting machine by means of the longitudinal carriage, wherein deposits on the one of the support bars of the second workpiece support are removed.

### BRIEF DESCRIPTION OF THE DRAWINGS

Further details of the invention and, in particular, exemplary embodiments of the device according to the invention and the method according to the invention are explained below with reference to the accompanying drawings. In the figures:

FIG. 1 shows a device for cleaning support bars of a first workpiece support of a first laser cutting machine in a perspective view,

FIG. 2 shows a cleaning head of the device of FIG. 1 connected to a guide arm in a perspective view,

FIG. 3 shows a bearing of the guide arm on a supporting structure of the device of FIG. 1 in a perspective view,

FIG. 4 shows a front view of the device of FIG. 1,

FIG. 5 shows a side view of the device of FIG. 1,

FIG. 6 shows a perspective view of the device at the location of the first laser cutting machine and a second laser cutting machine at another location, and

FIG. 7 shows method steps of a method for cleaning support bars of workpiece supports of laser cutting machines.

### DESCRIPTION OF EMBODIMENTS

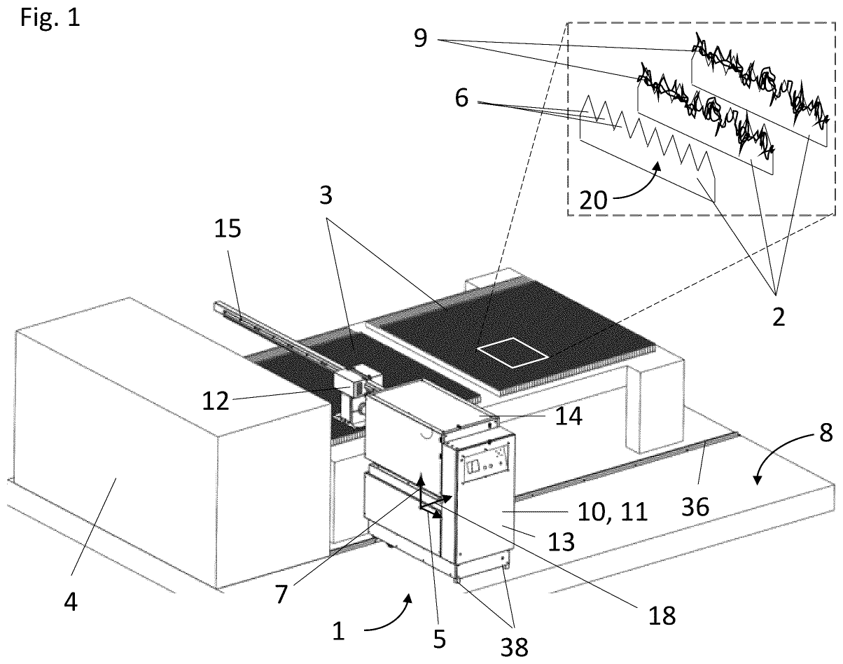

FIG. 1 schematically shows a device 1 for cleaning support bars 2 of a first workpiece support 3 of a first laser cutting machine 4, which is located at a predeterminable first location, in a perspective view, and an enlargement of the first workpiece support 3.

Essential elements of the first laser cutting machine 4 are not shown in FIG. 1 for the sake of clarity. The first laser cutting machine 4 is designed to process a workpiece by means of a laser. In doing so, an ablation process of a material of the workpiece takes place. For example, the workpiece can comprise a metallic material. In the laser cutting process, the workpiece can be cut through by means of the laser.

The first workpiece support 3 has a plurality of support bars 2 arranged substantially parallel to each other and each extending along a longitudinal direction 5 for supporting the workpiece. By way of example, the support bars 2 comprise a metallic material, but they can also comprise a different material. The support bars 2 have teeth 6 used to support the workpiece, wherein a contact surface of the support bars 2 with the workpiece is reduced by the teeth 6 of the support bars projecting away from a floor surface 8 at the first location along a vertical direction 7 perpendicular to the longitudinal direction 5. The number of teeth 6 shown in FIG. 1 is chosen merely as an example; the support bars 2 can each have any number of teeth 6. However, the support bars 2 need not necessarily have teeth 6. Alternatively, the support bars 2 can also have a different structure, for example a structure corrugated in the vertical direction 7.

During laser cutting, the workpiece rests on the support bars 2. The workpiece melts locally due to the ablation process, wherein the respectively generated melt partially reaches the first workpiece support 3, solidifies again at the first workpiece support 3 and thereby forms deposits 9 on the first workpiece support 3. In FIG. 1, three support bars 2 are shown by way of example in an enlarged illustration of a section of the workpiece support 3, of which, by way of example, two support bars 2 have deposits 9 which have accumulated during laser cutting.

The device 1 includes a supporting structure 10. By way of example, the supporting structure 10 includes a housing 11, which, however, is not absolutely necessary. It can be sufficient, for example, if the supporting structure 10 merely includes a frame. The supporting structure 10 carries a cleaning head 12 with a cleaning tool, which is not visible in the illustration of FIG. 1, for cleaning the support bars 2 of the first workpiece support 3.

The device 1 includes a movement mechanism for moving the cleaning head 12 relative to the supporting structure 10. The movement mechanism has a lifting mechanism (not shown in the figures) for lifting and lowering the cleaning head 12 in the vertical direction 7 to place the cleaning head 12 onto the support bars 2 of the first workpiece support 3 in such a manner that a support bar 2 comes into contact with the cleaning tool. After cleaning the support bar 2, the cleaning head 12 can be lifted from the support bars 2 of the first workpiece support 3 by means of the lifting mechanism.

The lifting mechanism is arranged within the supporting structure 10. The supporting structure 10 has a lower portion 13 and an upper portion 14. The cleaning head 12 is connected to the upper portion 14. The lifting mechanism is provided to move the upper portion 14 of the supporting structure 10 in a vertical direction 7. This allows the cleaning head 12 to be moved in the vertical direction 7 relative to the support bars 2. However, it is not absolutely necessary that the supporting structure 10 has a lower and an upper portion 13, 14, wherein the upper portion 14 to which the cleaning head 12 is connected is movable by means of the lifting mechanism. FIG. 1 shows an optional guide arm 15 to which the cleaning head 12 is connected. The lifting mechanism can also be designed, for example, to move only the guide arm 15 in the vertical direction 7, whereby the cleaning head 12 is also designed to be movable in the vertical direction 7. In the exemplary illustration of FIG. 1, in which the device 1 includes the guide arm 15, the guide arm 15 is connected to the upper portion 14 of the supporting structure 10 and the upper portion 14 of the supporting structure 10 can be moved or lifted and lowered in the vertical direction 7 by means of the lifting mechanism.

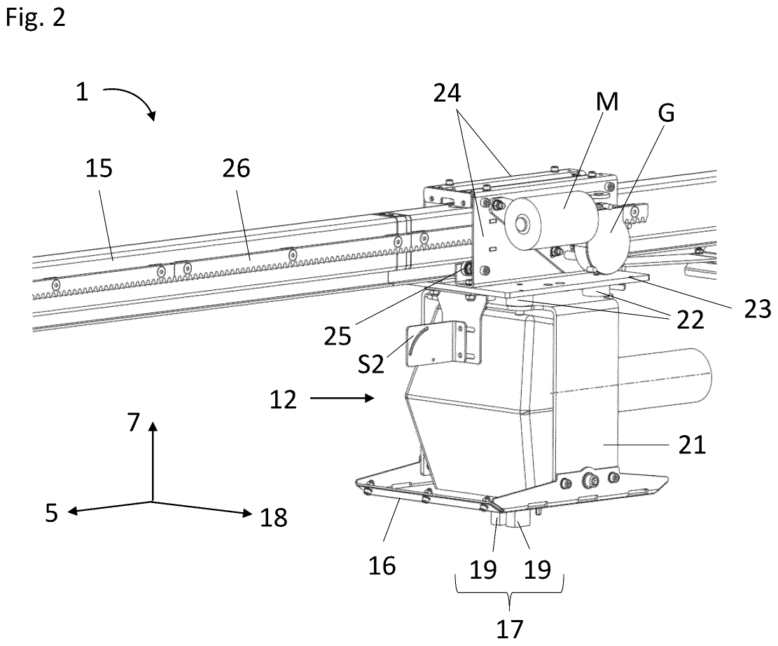

FIG. 2 schematically shows the cleaning head 12 connected to the optional guide arm 15 in detail in a perspective view. The reference signs of FIG. 1 are retained.

As an example, the cleaning head 12 has a guide plate 16 for supporting the cleaning head 12 on the support bars 2. The guide plate 16 determines the extent to which the cleaning head 12 can be lowered relative to the support bars 2. However, the guide plate 16 can also be omitted. Alternatively, for example, a desired vertical position of the cleaning head 12 can be stored in a memory of the device 1. This vertical position of the cleaning head 12 when cleaning the support bars 2 can then be specifically controlled by means of the lifting mechanism.

FIG. 2 shows the cleaning tool 17 of the cleaning head 12. The cleaning tool 17 projects through an opening in the guide plate 16 in the vertical direction 7. The cleaning tool 17 has two cleaning members 19, which are opposite one another with respect to a transverse direction 18 running perpendicular to the longitudinal direction 5 and perpendicular to the vertical direction 7, for receiving a support bar 2 of the first workpiece support 3. During cleaning of a support bar 2, the support bar 2 in question projects between the cleaning members 19 of the cleaning tool 17. As a result, the cleaning head 12 is guided along the support bar 2 during cleaning of a support bar 2. Optionally, the guide plate 16 rests on the support bar 2 to be cleaned and on adjacent support bars 2, thereby stabilizing the cleaning head 12 in the vertical direction 7. By way of example, the cleaning head 12 of FIG. 2 includes only one cleaning tool 17. However, the cleaning head 12 can include a plurality of cleaning tools 17 arranged, for example, side by side in the transverse direction 18 to clean a plurality of support bars 2 simultaneously.

The cleaning members 19 are each designed to be movable along the transverse direction 18 and the vertical direction 7, as a result of which the cleaning members 19 are designed to be movable relative to side surfaces 20 of one of the support bars 2 extending transverse to the transverse direction 18. As a result, the deposits 9 on one of the support bars 2 can be processed by grinding and/or scraping and removed by this processing.

For example, the cleaning members 19 can each be moved such that they are moved along a circular path or along an elliptical path in the plane spanned by the vertical direction 7 and the transverse direction 18. However, the cleaning members 19 can also be moved along other paths. It is essential that deposits 9 of a support bar 2 to be cleaned are mechanically processed by the movement of the cleaning members 19 in order to remove them. For example, the cleaning members 19 can be designed in a serrated manner in order to increase the scraping action on the deposits 9.

The guide plate 16 is connected to a holder 21. The holder 21 is attached to vibration dampers 22 and guides the guide plate 16. The vibration dampers 22 absorb most of the vibrations that occur during cleaning of a support bar 2 as a result of the grinding and scraping motion of the cleaning members 19 of the cleaning tool 17. In addition, the vibration dampers 22 can compensate for unevenness of the first workpiece support 3 and allow to evenly feed the guide plate. The vibration dampers 22 are fastened to a connecting plate 23. The connecting plate 23 is connected to two bearing shells 24. The bearing shells 24 include a ball bearing 25 which can absorb forces along the vertical direction 7 and along the transverse direction 18. The guide arm 15 projects through the bearing shells 24 or is embraced by them. The cleaning head 12 can be moved along the guide arm 15 by means of the ball bearing 25.

In addition to the lifting mechanism, the movement mechanism comprises a longitudinal carriage for moving the cleaning head 12 along the longitudinal direction 5 to move the cleaning head 12 along the support bars 2 of the first workpiece support 3. In the exemplary embodiment, the device 1 includes the guide arm 15 connected to the supporting structure 10. The guide arm 15 is alignable along the support bars 2 or along the longitudinal direction 5. In order to move the cleaning head 12 along the guide arm 15 or a support bar 2 to be cleaned, a longitudinal carriage is arranged on the cleaning head 12, which in the present example comprises a drive motor M with a gearbox G driven by the drive motor M, wherein the gearbox G allows the support bars to be cleaned slowly and powerfully. A pinion (not shown in the figures) is mounted at a gearbox output of the gearbox G. It engages with a rack 26 extending in the longitudinal direction of the guide arm 15. The design of this positive guide guarantees safe movement of the cleaning head 12 along the longitudinal direction 5. Should the cleaning head 12 become jammed, it can be released again by moving back. In FIG. 2, only the rack 26 is shown while the pinion mounted at the gearbox output is arranged behind one of the bearing shells 24 of the cleaning head 12 shown in FIG. 2 and is therefore not visible in FIG. 2.

However, it is not absolutely necessary that the cleaning head 12 includes the longitudinal carriage. For example, the supporting structure 10 can alternatively include the longitudinal carriage to move the cleaning head 12 along the guide arm 15. Alternatively, the longitudinal carriage can be designed to move the guide arm 15 along the longitudinal direction 5 or along the support bars 2. In this case, the cleaning head 12 can be fixedly connected to the guide arm 15. In another alternative embodiment, the guide arm 15 can be designed to extend telescopically by means of the longitudinal carriage to extend the guide arm along the support bars 2 or the longitudinal direction 5 and to move the cleaning head 12 along the support bars 2 or the longitudinal direction 5.

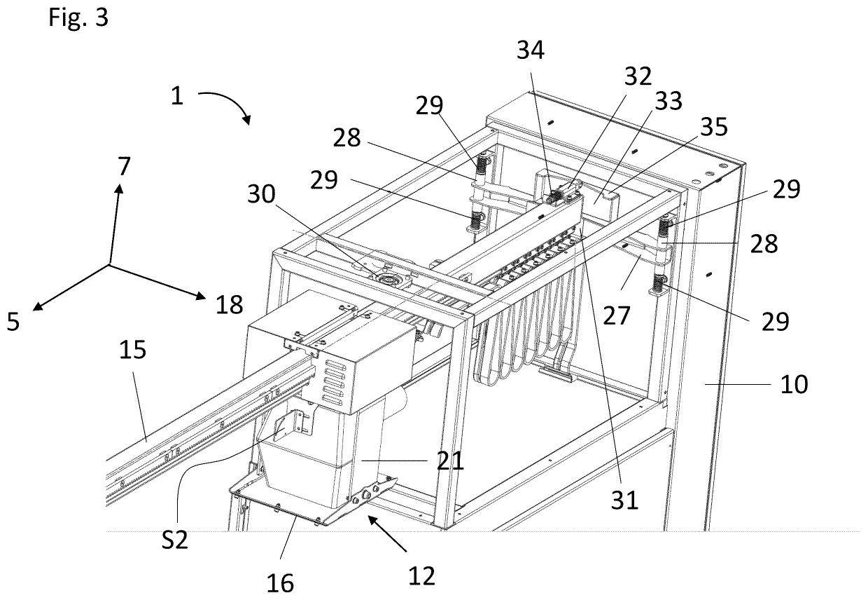

FIG. 3 schematically shows the supporting structure 10 with the optional guide arm 15 and the cleaning head 12 in a perspective view. The reference signs of FIG. 1 and FIG. 2 are retained. The housing 11 of the supporting structure 10 is not shown in FIG. 3. Instead, only a frame of the supporting structure 10 is shown to reveal elements inside the supporting structure 10.

To allow the cleaning head 12 connected to the guide arm 15 to adapt to unevenness of the first workpiece support 3 and the support bars 2 or the floor surface 8 during cleaning of a support bar 2 and during movement along the support bar 2, the guide arm 15 is pivotably mounted on the supporting structure 10 within a predeterminable solid angle.

For this purpose, the guide arm 15 is connected to the supporting structure 10 via a flange bearing 30. The flange bearing 30 forms a pivot point of the guide arm 15. For height compensation, the supporting structure 10 has a U-profile guide rail 27. The guide arm 15 has a lug 31 with a ball bearing, which can be guided in the U-profile guide rail 27. Along the transverse direction 18, the supporting structure 10 has guide shafts 28 arranged on both sides of the U-profile guide rail 27 and extending along the vertical direction 7 and in each case through the U-profile guide rail 27. Through the U-profile guide rail 27, the guide arm 15 is guided along the transverse direction 18, but can move freely along the guide shafts 28 or the vertical direction 7. Deflections of the guide arm 15 occurring in the vertical direction 7 are damped by springs 29, each of which is arranged running along the vertical direction 7 on both sides of the U-profile guide rail 27 along the guide shafts 28. The springs 29 limit a vertical movement of the guide arm 15. Vertical impacts generated during the cleaning process are transmitted via the guide arm 15 to the springs 29 and are damped by them.

In order to be able to position the guide arm 15 again in the center of the U-profile guide rail 27, a latching mechanism 32 of the guide arm 15 is pressed into a guide sheet 33 of the supporting structure 10. The latching mechanism 32 also includes another spring 34 extending along the guide arm. In the event of deflection of the guide arm in the transverse direction 18, the spring 34 of the latching mechanism 32 is compressed. As a result, the spring 34 exerts a spring force on the guide sheet 33 thereby pressing the guide arm 15 into a rest position centered on the U-profile guide rail 27. Another lug 35 arranged on the guide sheet 33 additionally limits a deflection of the guide arm 15 in the transverse direction 18. In the case of a curved support bar 2, the cleaning head 12 can follow the support bar 2 and automatically returns to the rest position when the support bar 2 is changed. The springs 29 and the further spring 34 of the latching mechanism 32 can compensate for irregularities over two axes. Overall, the guide arm 15 is thus mounted such that it can pivot within a predefinable solid angle. This flexibility of the guide arm 15 improves process reliability, in particular when cleaning support bars 2 which are shaped in such a manner that they do not extend in an exactly straight line in their longitudinal direction and are curved accordingly.

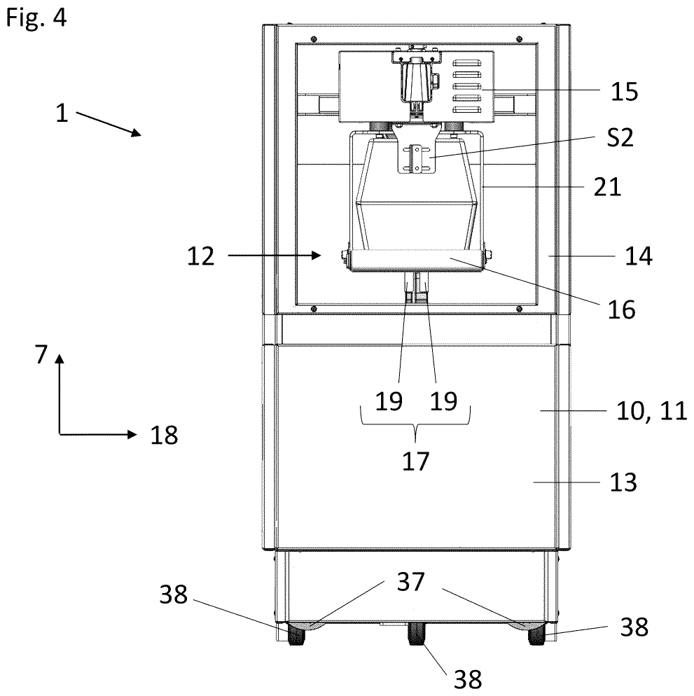

FIG. 4 schematically shows the device 1 in a front view of the guide arm 15. The reference signs of FIG. 1 to FIG. 3 are retained.

The supporting structure 10 includes a carriage for moving the supporting structure 10 on the floor surface 8 at the first location along the transverse direction 18. As a result, the supporting structure 10 is designed to be movable transverse to the support bars 2 or transverse to the longitudinal direction 5. Consequently, the cleaning head 12 can be moved from one support bar 2 to another support bar 2 to successively clean a plurality of support bars 2 of the first workpiece support 3 by means of the cleaning head 12.

With reference to FIG. 1, the supporting structure 10 is designed to be coupled to a guide rail 36 arranged on a base and extending along the transverse direction 18 for movement along the transverse direction 18. In FIG. 4, only the device 1 is shown, while the guide rail 36 is not shown for the sake of clarity. In FIG. 1, the guide rail 36 is arranged on the floor surface 8 as an example. In this case, the floor surface 8 forms the base. However, the guide rail 36 can also be arranged on a part of the first workpiece support 3 or on a part of the first laser cutting machine 4. In this case, the base is formed by a part of the first workpiece support 3 or the first laser cutting machine 4, such as a housing wall of the first laser cutting machine 4.

The supporting structure 10 can be guided along the transverse direction 18 by the guide rail 36. However, a guide rail 36 is not absolutely necessary to guide the supporting structure 10 along the transverse direction 18. Movement of the supporting structure 10 along the transverse direction 18 can also be programmed, for example. Alternatively, the supporting structure 10 can be designed to be guided along a laser beam to move the supporting structure 10 along the transverse direction 18. It is essential that the supporting structure 10 and thus the cleaning head 12 can be moved along the transverse direction 18 by means of the carriage.

In the present example, the carriage of the device 1 comprises two guide rollers 37 for coupling the supporting structure 10 to the guide rail 36. The device 1 can also include only one guide roller 37 or more than two guide rollers 37. The guide rollers 37 are arranged on an underside of the supporting structure 10 facing the floor surface 8. The supporting structure 10 has a lifting/lowering mechanism for lowering the guide rollers 37 onto the guide rail 36 and for lifting the guide rollers 37 from the guide rail 36. In the illustrated state of FIG. 4, the guide rollers 37 are lifted up.

In order to allow the supporting structure 10 to be moved on the floor surface 8, the carriage of the device 1 comprises at least three rollers 38 arranged on an underside supporting structure 10, by which means the supporting structure 10 is designed to be movable on the floor surface 8. At least one roller 38 should be designed to rotate about the vertical direction 7 so that the supporting structure 10 can be turned and aligned. When the guide rollers 37 are placed on the guide rail 36, it can be that at least one of the rollers 38 lifts off the floor surface 8. This applies in particular to rollers 38 arranged in the region of the guide rollers 37. These rollers 38 need not necessarily be designed to be rotatable about the vertical direction 7. They can also be rigidly connected to the supporting structure 10.

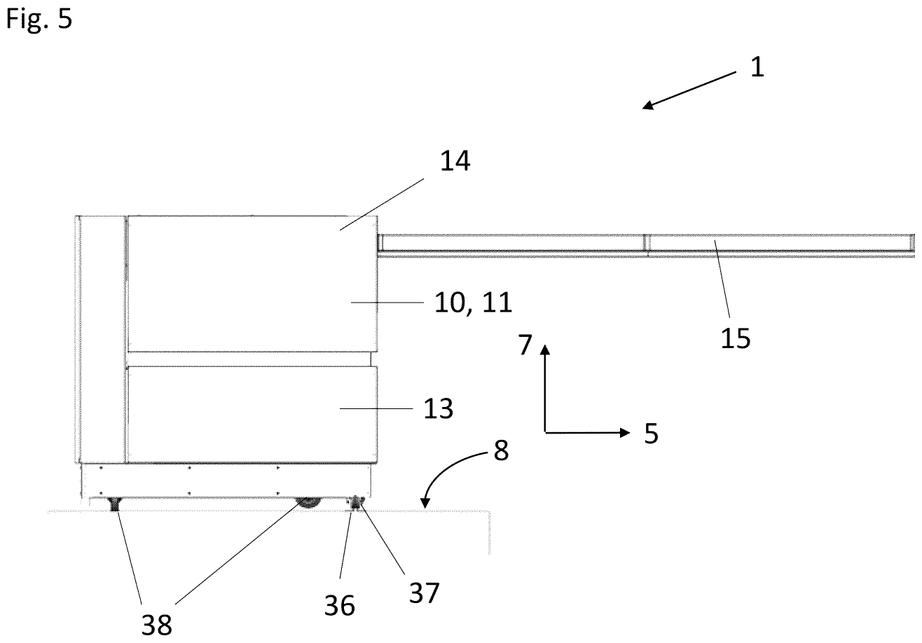

FIG. 5 schematically shows the device 1 of FIG. 4 in a side view. The reference signs of FIG. 4 are retained.

FIG. 5 shows the device 1 in a state in which the guide rollers 37 are placed on the guide rail 36. For coupling the guide rollers 37 to the guide rail 36, the guide rollers 37 have notches. The notches are provided for receiving the guide rail 36. As a result, the guide rollers 37 remain coupled to the guide rail 36 when the supporting structure 10 is moved along the transverse direction 18.

When the guide rollers 37 are lowered onto the guide rail 36, a portion of the supporting structure 10 is lifted up in the region of the guide rollers 37. In this manner, the greatest possible pressure can be generated on the guide rail 36 so that the supporting structure 10 is better guided on the guide rail 36. At least one of the rollers 38 and/or the at least one guide roller 37 can be driven by means of a drive (not shown in the figures) in order to move and guide the supporting structure 10 along the guide rail 36.

The supporting structure 10 can include a first sensor (not shown in the figures) (for example, a first optical sensor) positioned to be located above the guide rail 36 when the supporting structure 10 is coupled to the guide rail 36. The first sensor is designed to monitor whether the supporting structure 10 is guided along the guide rail 36 as intended. In extension of a respective last support bar 2 of the first workpiece support 3, the guide rail 36 has a recess. This can be detected by the first sensor, whereupon a cleaning process can be terminated. In this manner, in the event of an incorrect input in the course of a programming of the device 1, it can be prevented that the supporting structure 10 comes off the guide rail 36 at one end of the guide rail 36.

The device 1 can additionally include a rotary encoder for the carriage. The rotary encoder is designed to detect a distance traveled by the supporting structure 10. During a movement the supporting structure 10, it is possible that initially only the distance traveled is relevant for controlling the supporting structure 10 along the transverse direction 18. Thus, interfering contours or curved support bars 2 can initially be neglected. After a predeterminable distance, which substantially corresponds to a distance between two directly adjacent support bars 2, a second sensor S2 (for example a laser sensor) arranged on the cleaning head 12 can be used to detect one of the support bars 2 in order to control the movement of the supporting structure 10. As soon as the second sensor S2 detects a support bar 2, the movement of the supporting structure 10 along the transverse direction 18 is stopped. In this manner it can be prevented that the cleaning head 12 already starts the cleaning process between the support bars 2.

A desired cleaning length along the transverse direction 18 can be set before or during the cleaning process. If only small workpieces are processed with the first laser cutting machine 4, which do not cover the entire surface area of the first workpiece support 3, the latter does not have to be completely cleaned. Thus, the time of cleaning and a standstill of the cleaning process can be minimized. The cleaning length is determined by adding the distance between the support bars 2 for each sideways movement. If a total length of the movement of the supporting structure 10 along the transverse direction 18 corresponds to a predefinable length, the cleaning program is discontinued.

A travel speed of the cleaning head 12 along the longitudinal direction 5 can be adjusted during the cleaning process. A controller of the device 1 is configured to determine an output value, based on which a power for the drive motor M of the longitudinal carriage can be adjusted. The drive motor M can include a rotary encoder. The rotary encoder is used to detect an instantaneous position and a speed of the cleaning head 12 with respect to the longitudinal direction of the guide arm 15 when the cleaning head 12 is moved in the longitudinal direction of the guide arm 15. For controlling the cleaning head 12 along the longitudinal direction 5, a specifiable speed profile of the cleaning head 12 can be stored in a memory of the device 1. Based on the speed profile, a target value for the rotary encoder can be determined. This target value can be compared with a detected value of the rotary encoder. If a deviation tolerance is not reached, the direction of rotation of the motor changes. In the event of a further increase in force, the device 1 switches off. If the cleaning head 12 jams in a support bar 2, a direction of movement of the cleaning head 12 can be changed.

If another jamming is detected when moving back, the direction of movement is changed again. The cleaning head 12 can be moved along the longitudinal direction 5 and along a support bar 2 until a predeterminable cleaning depth is reached. The process of reversing the direction of movement can be repeated up to three times, for example. If the cleaning head 12 cannot free itself after the third attempt, the cleaning program is interrupted.

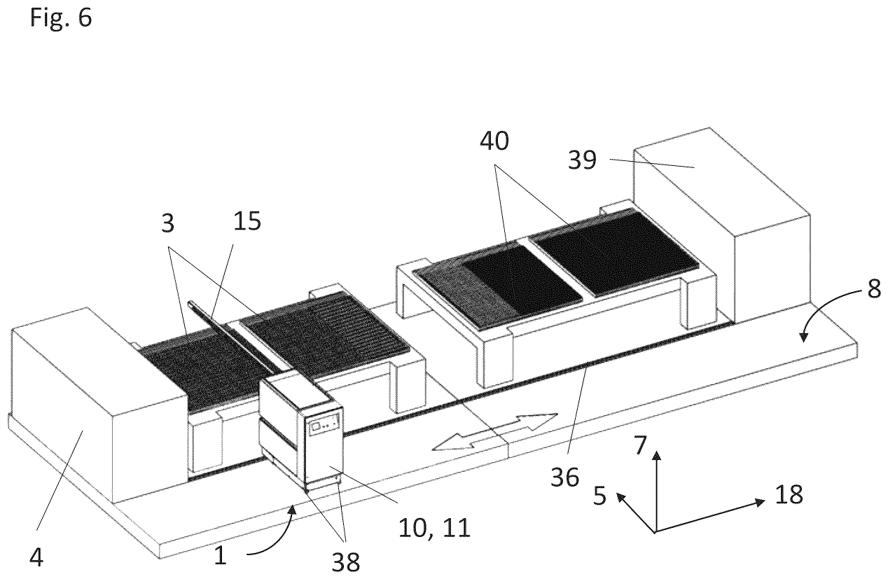

FIG. 6 shows a perspective view of the device 1 at the first location of the first laser cutting machine 4 and a second laser cutting machine 39 which is arranged at a second location remote from the first location of the first laser cutting machine 4. All previous reference signs are retained in the following.

The supporting structure 10 is movable over the floor surface 8 by means of the carriage in such a manner that the supporting structure 10 is designed to be movable towards the first location of the first laser cutting machine 4 in order to clean support bars 2 of the first workpiece support 3 of the first laser cutting machine, and that the supporting structure 10 is designed to be movable away from the first location of the first laser cutting machine 4 in order to move the supporting structure 10 to the second location of the second laser cutting machine 39 and to clean support bars 2 of a second workpiece support 40 of the second laser cutting machine 39. As a result of this, the supporting structure 10 with cleaning head 12 is designed to be spatially mobile and independent of the location. FIG. 6 shows merely as an example that a common guide rail 36 is provided on the floor surface 8 for the first laser cutting machine 4 and for the second laser cutting machine 39. However, this is not absolutely necessary. Rather, a separate guide rail can also be provided for the second laser cutting machine 39. In principle, guide rails 36 are not required. The supporting structure 10 can be moved towards and away from the first laser cutting machine 4 and the second laser cutting machine 39 by means of the carriage and without a guide rail 36.

Advantageously, the device 1 can be operated independently of its location. In addition, the movements of the cleaning head 12 and the supporting structure 10 are fully automated, as a result of which the entire cleaning process can be automated. Electric motors are provided in each case for the lifting mechanism, the longitudinal carriage and the carriage, which are arranged in the cleaning head 12 and/or on or in the supporting structure 10 and allow automated movement in all required directions.

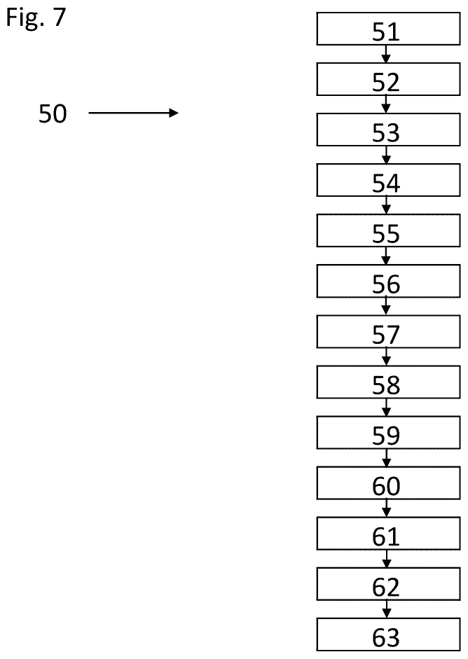

FIG. 7 schematically shows process steps 51, 52, 53, 54, 55, 56, 57, 58, 59, 60, 61, 62, 63 of a method 50 for cleaning support bars 2 of the first workpiece support 3 of the first laser cutting machine 4 by means of a device 1 according to FIGS. 1 to 6.

Within a first method step 51, the supporting structure 10 is moved towards the first location of the first laser cutting machine 4. In a second method step 52, the supporting structure 10 is aligned such that the cleaning head 12 is movable along the support bars 2. In a third method step 53, the cleaning head 12 is placed onto the support bars 2 of the first workpiece support 3 of the first laser cutting machine 4 by means of the lifting mechanism. In doing so, the cleaning tool 17 comes into contact with a support bar 2 or the support bar engages with the cleaning elements 19 of the cleaning tool 17. In a fourth method step 54, the cleaning head 12 is moved along the support bar 2 by means of the longitudinal carriage, thereby cleaning the support bar 2.

Only optional method steps 55, 56, 57, 58, 59, 60, 61, 62, 63 are explained below. In a fifth method step 55, the cleaning head 12 is lifted off the support bars 2 by means of the lifting mechanism. In a sixth method step 56, the supporting structure 10 is moved along the transverse direction 18 by means of the carriage, wherein the cleaning head is moved towards a further support bar 2. In doing so, the supporting structure 10 can be moved and guided, for example, along the guide rail 36 which is arranged extending along the transverse direction 18. In a seventh method step 57, the cleaning head 12 is placed onto the support bars 2 of the workpiece support 3 of the first laser cutting machine 4 by means of the lifting mechanism, as a result of which the cleaning tool 17 comes into contact with a further support bar 2. In an eighth method step 58, the cleaning head 12 is moved along the further support bar 2 by means of the longitudinal carriage thereby cleaning the further support bar 2.

In a ninth method step 59, lifting the cleaning head 12 from the first workpiece support 3 of the first laser cutting machine 4 is carried out by means of the lifting mechanism. In a tenth method step 60, the supporting structure 10 is moved towards the second laser cutting machine 39. In an eleventh method step 61, aligning the supporting structure 10 is carried out in such a manner that the cleaning head 12 can be moved along support bars 2 of the second workpiece support 40 of the second laser cutting machine 39. In a twelfth method step 62, the cleaning head 12 is placed onto a support bar 2 of the second workpiece support 40 of the second laser cutting machine 39 by means of the lifting mechanism, as a result of which the cleaning tool 17 comes into contact with a support bar 2 of the second workpiece support 40. In a thirteenth process step 63, the cleaning head 12 is moved along the support bar 2 of the second workpiece support 40 of the second laser cutting machine 39 by means of the longitudinal carriage, as a result of which deposits 9 are removed from the support bar 2.

Thus, although only a few embodiments of the present invention have been shown and described, it is to be understood that many changes and modifications may be made thereunto without departing from the spirit and scope of the invention.

What is claimed is:

1. A device (1) for cleaning support bars (2) of a first workpiece support (3) of a first laser cutting machine (4),
wherein the first laser cutting machine (4) is located at a predeterminable first location,
wherein the first workpiece support (3) of the first laser cutting machine (4) includes a plurality of support bars (2) which are arranged to run substantially parallel to one another and each extend along a longitudinal direction (5), for supporting a workpiece,
wherein the device (1) includes a supporting structure (10) supporting a cleaning head (12) with a cleaning tool (17) for cleaning the support bars (2) of the first workpiece support (3), and a movement mechanism for moving the cleaning head (12) relative to the supporting structure (10),
wherein the movement mechanism includes a lifting mechanism for lifting and lowering the cleaning head (12) in a vertical direction (7) to place the cleaning head (12) onto the support bars (2) of the first workpiece support (3) so that a support bar (2) comes into contact with the cleaning tool (17), and to lift the cleaning head (12) from the support bars (2) of the first workpiece support (3) after cleaning the support bar (2),
wherein the movement mechanism includes a longitudinal carriage (M, G) for moving the cleaning head (12) along the longitudinal direction (5) to move the cleaning head (12) along the support bars (2) of the first workpiece support (3),
wherein the supporting structure (10) includes a carriage (37, 38) for moving the supporting structure (10) on a floor surface (8) at the first location along a transverse direction (18) extending transverse to the longitudinal direction (5), as a result of which the supporting structure is designed to be movable transverse to the support bars (2) in order to move the cleaning head (12) from support bar (2) to support bar (2) so that multiple support bars (2) of the first workpiece support (3) are enabled to be successively cleaned by means of the cleaning head (12), and
wherein the supporting structure (10) is movable over the floor surface (8) by means of the carriage (37, 38) in such a manner that the supporting structure (10) is configured to be movable towards the first location of the first laser cutting machine (4) in order to clean support bars (2) of the first workpiece support (3) of the first laser cutting machine (4) and that the supporting structure (4) is configured to be moved away from the first location of the first laser cutting machine (4) and to be moved towards a predeterminable second location of a second laser cutting machine (39) in order to clean support bars (2) of a second workpiece support (40) of the second laser cutting machine (39) by means of the cleaning head (12).

2. The device (1) according to claim 1, wherein the cleaning head (12) has a guide plate (16) for supporting the cleaning head (12) on the support bars (2).

3. The device (1) according to claim 1, including a guide arm (15) connected to the supporting structure (10) and alignable along the support bars (2),
wherein the cleaning head (12) is guided on the guide arm (15) in such a manner that the cleaning head (12) is movable along the guide arm (15) by means of the longitudinal carriage (M, G).

4. The device (1) according to claim 3, wherein the guide arm (15) is pivotably mounted on the supporting structure (10) within a predeterminable solid angle.

5. The device (1) according to claim 1,
wherein the cleaning tool (17) of the cleaning head (12) includes two cleaning members (19) opposite each other with respect to the transverse direction (18) for receiving one of the support bars (2), and
wherein the cleaning members (19) are each designed to be movable along the transverse direction (18) and the vertical direction (7), as a result of which the cleaning members (19) are designed to be movable relative to side surfaces (20), which run transverse to the transverse direction (18), of the one of the support bars (2) in order to process deposits (9) on the one of the support bars (2) by grinding and/or scraping.

6. The device (1) according to claim 1, wherein the supporting structure (10) is configured to be coupled to a guide rail (36) arranged on a base (8) and extending along the transverse direction (18) in order to enable the supporting structure (10) to be moved along the transverse direction (18).

7. The device (1) according to claim 6, wherein the carriage comprises at least one guide roller (37) which is arranged on an underside of the supporting structure (10) facing the floor surface (8) and is configured to be coupled to the guide rail (36) in such a manner that the supporting structure (10) is guided on the guide rail (36) by means of the guide roller (37) so that the supporting structure (10) is enabled to be moved in the longitudinal direction of the guide rail (36).

8. The device (1) according to claim 7, wherein the supporting structure (10) includes a lifting/lowering mechanism for lowering the guide roller (37) onto the guide rail (36) and for lifting the guide roller (37) from the guide rail (36).

9. The device (1) according to claim 1, wherein the carriage comprises at least three rollers (38) arranged on an underside of the supporting structure (10) facing the floor surface (8) for moving the supporting structure (10) on the floor surface (8).

10. The device (1) according to claim 6, wherein at least one of the rollers (38) and/or the at least one guide roller (37) is drivable by means of a drive to move the supporting structure (10) along the guide rail (36).

11. A method (50) for cleaning support bars (2) of a first workpiece support (3) of a first laser cutting machine (4) by means of the device (1) according to claim 1 with the following method steps (51, 52, 53, 54):
moving the supporting structure (10) to the first location of the first laser cutting machine (4),
aligning the supporting structure (10) in such a manner that the cleaning head (12) is movable along the support bars (2),
placing the cleaning head (12) onto the support bars (2) of the first workpiece support (3) of the first laser cutting machine (4) by means of the lifting mechanism so that the cleaning tool (17) comes into contact with one of the support bars (2), and
moving the cleaning head (12) along the one of the support bars (2) by means of the longitudinal carriage thereby cleaning the one of the support bars (2).

12. The method (50) according to claim 11 comprising the following further method steps (55, 56, 57, 58):
lifting the cleaning head (12) off the support bars (2) by means of the lifting mechanism,
moving the supporting structure (10) along the transverse direction (18) by means of the carriage, wherein the cleaning head (12) is moved towards another one of the support bars (2),
placing the cleaning head (12) onto the support bars (2) of the workpiece support (3) of the first laser cutting machine (4) by means of the lifting mechanism, wherein the cleaning tool (12) comes into contact with the other one of the support bars (2), and
moving the cleaning head (12) along the other one of the support bars (2) by means of the longitudinal carriage thereby cleaning the other one of the support bars (2).

13. The method (50) according to claim 11, comprising the following further method steps (59, 60, 61, 62, 63):
lifting the cleaning head (12) from the first workpiece support (3) of the first laser cutting machine (4) by means of the lifting mechanism,
moving the supporting structure (10) towards the second laser cutting machine (39),
aligning the supporting structure (10) in such a manner that the cleaning head (12) is movable along support bars (2) of the second workpiece support (40) of the second laser cutting machine (39),
placing the cleaning head (12) onto one of the support bars (2) of the second workpiece support (40) of the second laser cutting machine (39) by means of the lifting mechanism, wherein the cleaning tool (12) comes into contact with the one of the support bars (2) of the second workpiece support (40), and
moving the cleaning head (12) along the one of the support bars (2) of the second workpiece support (40) of the second laser cutting machine (39) by means of the longitudinal carriage, wherein deposits (9) are removed from the one of the support bars (2) of the second workpiece support (40).
